(19) United States
(12) Patent Application Publication
(10) Pub. No.: US 2006/0036483 A1
(43) Pub. Date: Feb. 16, 2006

(54) System for managing advertisement in shopping mall web site, and method of the same

(76) Inventor: Suk-Won Jang, Inchon City (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017-5554, US

(21) Appl. No.: 10/916,992

(22) Filed: Aug. 11, 2004

(51) Int. Cl. G06Q 30/00

(52) U.S. Cl. 705/14

(57) ABSTRACT

A system designed to manage an advertisement in a shopping mall web site. The system comprises a shopping mall advertisement management server for displaying information of products, to be offered at no profit margin to a supplier, for performing calculation of points required for the client to purchase a product, and then offering calculated points to the client, thereby performing purchase and payment settlement for the product in real time; a client terminal with a communication module embedded therein, and a web browser for generating an advertisement connection signal while allowing the client to view an advertisement; and a company server for offering information of products and of the number of products while being offered with information of calculation of the payment for advertising on a per client basis. The system allows the client to purchase a desired product using the points achieved through the advertisement viewing, and enhances advertising effects of the company.

### BACKGROUND OF THE INVENTION

1. Field of the Invention

The present invention relates to a system for managing an advertisement in a shopping mall web site, and a method of managing the advertisement in the shopping mall web site. More particularly, the present invention relates to a system for managing an advertisement in a shopping mall web site, which offers information of products to be sold at no profit margin to a supplier after receiving the information of products to be sold at no profit margin to the supplier from a plurality of companies, issues points according to advertisement viewing time and the number of clicks by a client on a banner advertisement or a text advertisement, provided in the shopping mall web site while being linked to a URL address of a web site advertised by the advertisement, and which automatically sends information of a specific product, previously determined as a product, to be sold at no profit margin to the supplier, offered from the plurality of companies, when the points reaches or exceeds a predetermined value, and a method of managing the advertisement in the shopping mall web site.

2. Description of the Related Art

As is well known in the prior art, due to recent improvement in information communication technology, information technology for supplying information of various fields from at least one host server to a plurality of subscribers via a remote data communication network has been actively developed.

Based on the development of the information technology, a recent trend focuses on development of a compression technology, an information classifying technology, which allows the subscribers to comfortably access predetermined information according to their tastes and preferences, and of a peripheral technology, such as a memory extension technology for rapidly supplying more accurate information to the subscribers, and thus development of various kinds of content and solutions has also been accelerated using these technologies.

Recently, for the purpose of winning over clients as one of the principle matters in all commercial transactions, an on/off-line linked reserve fund award system has been used. According to this system, when the client purchases a product offered by many member stores suggested by a predetermined company or from affiliated companies on an on-line shopping mall, the predetermined company affords a predetermined reserve fund, and when the predetermined reserve fund is accumulated to a certain points or more, money or products corresponding to the accumulated reserve fund will return back to the client.

In case of the above mentioned reserve fund award system, after receiving the money converted from the reserve fund attributed to the purchase of the products, the client can use the money. However, in this case, since the client must perform an additional application process for receiving the money, a long period of time is required for the client to receive the money, and the additional application process is very cumbersome. Further, in the case where the client receives the products corresponding to the reserve fund, since the kind of product which can be selected by the client is very restrictive, it frequently happens that the client cannot choose a desired product, directing the client to repetitiously order a product identical to one already possessed by the client.

That is, the conventional Internet shopping mall has a problem in that, since the purchase on the on-line shopping mall is not compatible with other aspect of the on-line shopping mall, the reserve fund attributed to the purchase of the client on the on-line shopping mall becomes meaningless to the client.

Further, as for other kinds of reserve fund award systems, there is a system wherein when the client continuously views an advertisement for a predetermined period on the online shopping mall, a gift is awarded to the client. However, like the above reserve fund award system, there is a problem in that, in the case where the client views the advertisement for a predetermined period, which does not satisfy a period limit required for acquiring the benefit, interest of the client in the advertisement cannot be maintained for a long time because there is no system which allows a client to purchase a product using points corresponding to the advertisement viewing time of the client. Further, there is another problem in that the system cannot actively direct the clients who view the advertisements for acquiring the gifts to purchase the products on the online shopping mall.

### SUMMARY OF THE INVENTION

The present invention has been made to solve the above problems, and it is an object of the present invention to provide a system for managing an advertisement in a shopping mall web site, which offers information of products to be sold at no profit margin to a supplier after receiving the information of products to be sold at no profit margin to the supplier from a plurality of companies, issues points according to advertisement viewing time and the number of clicks by a client on a banner advertisement or a text advertisement, provided in the shopping mall web site while being linked to a URL address of a web site advertised by the advertisement, and which automatically offers a specific product, previously determined as a product to be sold at no profit margin to the supplier, when the points reaches or exceeds a predetermined value, and a method of managing the advertisement in the shopping mall web site.

It is further object of the present invention to provide a system for managing an advertisement in a shopping mall web site, which offers information of products to be sold at no profit margin to a supplier after receiving the information of products to be sold at no profit margin to the supplier from a plurality of companies, issues points according to advertisement viewing time and the number of clicks by a client on a banner advertisement or a text advertisement, provided in the shopping mall web site while being linked to a URL address of a web site advertised by the advertisement, and which automatically displays information of a specific product, previously determined as a product to be sold at no profit margin to the supplier, when the points reaches or exceeds a predetermined value, and a method of managing the advertisement in the shopping mall web site.

It is another object of the present invention to provide a system for managing an advertisement in a shopping mall web site, which offers information of products to be sold at no profit margin to a supplier after receiving the information of products to be sold at no profit margin to the supplier from a plurality of companies, issues points according to advertisement viewing time and the number of clicks by a client on a banner advertisement or a text advertisement, provided in the shopping mall web site while being linked to a URL address of a web site advertised by the advertisement, automatically offers information of a specific product, previously determined as a product to be sold at no profit margin to the supplier, when the points reaches or exceeds a predetermined value, and which transmits a web page, provided as a popup window having a plurality of Internet banking payment tools for the products displayed thereon, for allowing the client to perform a payment settlement process in real time without moving to another web site for the payment settlement, and a method of managing the advertisement.

It is yet another object of the present invention to provide a system for managing an advertisement in a shopping mall web site, which offers a product offered from a plurality of companies at no profit margin, while according to a choice of the client, offering the product to be purchased by a client at a price discounted by a predetermined price corresponding to points, having been accumulated before current purchase of the product adds additional points to the previously accumulated points.

In accordance with one aspect of the present invention, the above and other objects can be accomplished by the provision of a system for managing an advertisement in a shopping mall web site, comprising: a shopping mall advertisement management server for managing a plurality of shopping mall web sites, for displaying information of products, to be offered at no profit margin to a supplier, after receiving the information of products from a company, for performing calculation of points required for the client to purchase a product by reducing a profit margin of the product in proportion to advertisement viewing time and the number of clicks on an advertisement by the client, based on an agreement as to payment for advertising on a per client basis, and then offering calculated points to the client connected to the shopping mall advertisement management server, thereby performing purchase and payment settlement for the product in real time; a client terminal with a communication module embedded therein, such as a modem or a dedicated cable, and a web browser for generating an advertisement connection signal while allowing the client to view the advertisement after connecting to the shopping mall advertisement management server for managing the plurality of shopping mall web sites; and a company server for offering the information of products and of the number of products to be offered to the client at no profit margin to the supplier while being offered with information of calculation of the payment for advertising on a per client basis according to the advertisement viewing time and the number of clicks on the advertisement by the client connected to the company server via the shopping mall advertisement management server when the shopping mall advertisement management server is connected to the company server.

The shopping mall management server may offer an advertisement shopping-tool to the client terminal for automatically updating the information of products which may be purchased at no profit margin to the supplier by the client using the client's points, together with information of products which may be purchased at a discounted price by using the points accumulated by the client to discount the price of the product, in the web browser on the client terminal.

The information of products offered by the shopping mall advertisement management server may be classified into information of products which may be purchased at no profit margin to the supplier by the client, using the points accumulated by the client, information of a discounted price of the product, and information of products to be only discounted in price.

The system may further comprise an account server for offering an Internet banking payment tool to the shopping mall advertisement management server, and the Internet banking payment tool may be linked in a multi-tasking to the account server such that the Internet banking payment tool can be automatically operated in a web browser on the client terminal.

The shopping mall advertisement management server may transmit information of a client's bank, certified in the client terminal, and of a location of a certificate to the account server to perform payment settlement.

In accordance with another aspect of the present invention, there is provided a method of managing an advertisement in a shopping mall web site, comprising the steps of: a) receiving a signal to access a shopping mall advertisement management server by a client through a client terminal; b) certifying a client's identity in the shopping mall advertisement management server; c) offering an advertisement shopping-tool to the client terminal from the shopping mall advertisement management server such that the advertisement shopping-tool may be installed in the client terminal; d) issuing points to the client in proportion to advertisement viewing time and the number of clicks on an advertisement by the client when receiving a signal indicating advertisement viewing, transmitted from the client terminal; e) updating client's points by performing calculation; f) receiving a signal to access a shopping mall in the shopping mall web site by the client through the client terminal; g) extracting and transmitting information of products to be purchased at no profit margin to a supplier by the client using points accumulated by the client, and information of products to be purchased at a discounted price by the client to the client terminal; h) displaying the information of products to be purchased at no profit margin to the supplier by the client using the points accumulated by the client, on the client terminal, after classifying information of products, to be purchased using the client's points, corresponding to the client; i) receiving a purchasing signal and a payment settlement signal transmitted from the client terminal; j) verifying payment settlement on account from the client terminal; and k) performing shipment of the product purchased by the client.

The shopping mall advertisement management server may automatically offer the information of products which may be purchased at no profit margin to the supplier by the client using client's points, and information of products which may be purchased at a discounted price by the client when receiving the signal to access the shopping mall advertisement management server by the client through the client terminal.

The points issued according to the advertisement viewing time and the number of clicks by the client may be restricted to a daily limit.

The method may further comprise the steps of l) generating payment settlement command information performed according to the payment settlement signal transmitted from the client terminal, m) transmitting payment settlement command information to the account server through the shopping mall advertisement management server, and n) receiving payment settlement verification information automatically transmitted from the shopping mall advertisement management server to an IP address of the shopping mall advertisement management server included in the payment settlement command information.

### BRIEF DESCRIPTION OF THE DRAWINGS

The foregoing and other objects and features of the present invention will be more clearly understood from the following detailed description taken in conjunction with the accompanying drawings, in which:

FIG. 1 is a diagram illustrating the schematic configuration of a system for managing an advertisement in a shopping mall web site according to a first embodiment of the present invention;

FIG. 2 is a block diagram illustrating the schematic configuration of the system for managing the advertisement in the shopping mall web site according to the first embodiment of the present invention;

FIGS. 3a, 3b and 3c are diagrams illustrating a display in a web browser on a client terminal in the system for managing the advertisement in the shopping mall web site according to the first embodiment of the present invention;

FIGS. 4a, 4b and 4c are diagrams illustrating another display in the web browser on the client terminal in the system for managing the advertisement in the shopping mall web site according to the first embodiment of the present invention;

FIG. 5 is a flow diagram depicting signal flow in the system for managing the advertisement in the shopping mall web site according to the first embodiment of the present invention;

FIG. 6 is a diagram illustrating the schematic configuration of a system for managing an advertisement in a shopping mall web site according to a second embodiment of the present invention;

FIG. 7 is a diagram illustrating a payment settlement tool linked to the system for managing the advertisement in the shopping mall web site according to the second embodiment of the present invention;

FIGS. 8a and 8b are diagrams illustrating displays of the payment settlement tool linked to the shopping mall web site in the system for managing the advertisement in the shopping mall web site according to the second embodiment of the present invention;

FIG. 9 is a diagram illustrating a data frame transmitted to an account server from the system for managing the advertisement in the shopping mall web site according to the second embodiment of the present invention; and

FIG. 10 is a flow chart depicting signal flow in the system for managing the advertisement in the shopping mall web site according to the second embodiment of the present invention.

### DESCRIPTION OF THE PREFERRED EMBODIMENTS

Preferred embodiments will now be described in detail with reference to the accompanying drawings.

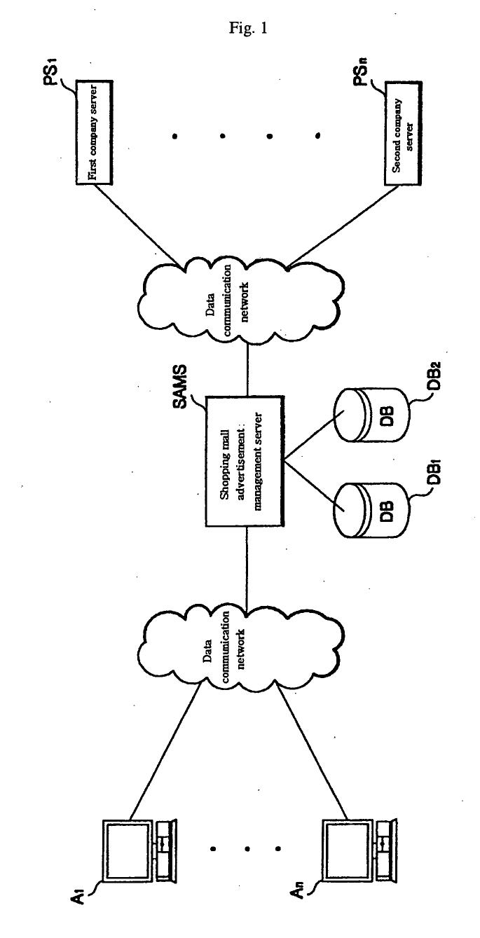

FIG. 1 is a diagram illustrating the schematic configuration of a system for managing an advertisement in a shopping mall web site according to a first embodiment of the present invention.

Referring to FIG. 1, the system for managing the advertisement in the shopping mall web site according to the first embodiment of the invention receives information of a plurality of products to be sold at no profit margin, supplied from a plurality of companies, and issues points to a client after detecting an advertisement viewed by the client, advertisement viewing time, the number of clicks on the advertisement, and the like, when the advertisement linked to the shopping mall web site is viewed by the client after the client accesses the shopping mall web site via an associated client terminal among client terminals A1˜An. Here, an agreement as to payment for advertising on a per client basis, which is related to the number of clicks on the advertisement and to the advertisement viewing time, is previously negotiated between each of the companies and the system. Different from a typical points generated by product purchase, the points, issued by the system depending on the advertisement viewing time and the like, allow the client to purchase a desired product at no profit margin to the supplier under the condition that the points issued to the client are applied to a profit margin of the product to be offered to the client at no profit margin.

Here, a plurality of shopping mall web sites linked to the system for managing the advertisement in the shopping mall web site according to the first embodiment of the present invention selectively supply the product to the client, such that the client can purchase the product at no profit margin to the supplier by using the points. That is, each of the shopping mall web sites selects a predetermined product, and offers it to the client as a product to be sold at no profit margin to the supplier.

Meanwhile, the points issued to the client when the client views the advertisement is a gift corresponding to a portion of payment for advertising on a per client basis to be provided to the system for managing the advertisement in the shopping mall web sites. Accordingly, in order to secure the points corresponding to the profit margin of the desired product, the client must view the advertisement for a predetermined time or more every day. Further, in order to activate the shopping mall site using reserve points attributed to the advertisement viewing as described above, the system for managing the advertisement in the shopping mall web site allows the client to purchase the desired product at any time by applying a discount rate, corresponding to the reserve points of the client, to a price of the product, even if the reserve points of the client do not correspond to the profit margin of the desired product. Further, when the client purchases the product, the system for managing the advertisement in the shopping mall web site issues predetermined points to the client.

That is, the advertisement, the points, and the shopping mall are related to each other in the management system. Accordingly, although, instead of offering the product, the system for managing the advertisement in the shopping mall web site issues the points to the client such that the product can be offered to the client at no profit margin to the supplier, if the client has viewed the advertisement for a predetermined time or more, the client can purchase the product at a discounted price using points accumulated by the client during the advertisement viewing, whereby purchasing desire is enhanced.

Further, the system for managing the advertisement in the shopping mall web site according to the first embodiment of the present invention is adapted such that product information associated with points of many clients can be classified according to the clients, and offered to the respective clients in a web browser tool installed on the desktop of client terminals. Here, the web browser tool is dedicated to the system for managing advertisements in the shopping mall web site. Accordingly, the product information associated with the points of the clients may be offered to the respective clients through data update for each of the clients by installation of the web browser tool for the client on the associated client terminal.

Meanwhile, the system for managing the advertisement in the shopping mall web site according to the first embodiment of the invention may offer information of products which may be purchased at no profit margin to the supplier by the client using the accumulated points, together with information of products which cannot be purchased at no profit margin to the supplier by the client. Accordingly, the system for managing the advertisement in the shopping mall web site allows the client to verify the product which the client desires to purchase using the points, while enhancing the client to purchase other products.

For this purpose, the system for managing the advertisement in the shopping mall web site according to the first embodiment is provided with client terminals A1˜An. Each of the terminals is embedded with a communication module, such as a modem or a dedicated cable, and a web browser for generating an advertisement connection signal while allowing the client to view the advertisement after connecting to an advertisement management server.

Furthermore, the system for managing the advertisement in the shopping mall web site according to the first embodiment of the invention is provided with company servers PS1˜PSn, each of which offers information of products and the number of products to be offered to the client at no profit margin to the supplier while being offered with information of calculation of an advertisement cost according to the advertisement viewing time and the number of clicks on the advertisement by the client connected to the company server via the advertisement management server when the system server for managing a plurality of shopping mall web sites is connected to the company server.

Meanwhile, the system for managing the advertisement in the shopping mall web site according to the first embodiment of the invention is provided with a shopping mall advertisement management server SAMS for displaying the information of products to be offered at no profit margin to the supplier after receiving the information of products from the company servers PS1˜PSn, and for performing calculation of the points required for the client to purchase the product by reducing a profit margin of the product in proportion to the advertisement viewing time and the number of clicks on the advertisement, based on an agreement as to payment for advertising on a per client basis, and then offering the calculated points to the client connected to the shopping mall advertisement management server via the client terminals A1˜An, thereby performing purchase and payment settlement for the product in real time.

Particularly, the shopping mall advertisement management server SAMS offers the information of products which may be purchased at no profit margin to the supplier by the client using the client's points, and other product information, including discount information, with the accumulated points applied to the discount information, such that these pieces of product information can be updated every day in the web browser on the associated terminal among the client terminals A1˜An through the advertisement shopping-tool (not shown) previously installed on the client terminal.

The shopping mall advertisement management server SAMS is provided with first and second databases DB1 and DB2, in which client information, points information of respective clients, information of products which may be purchased at no profit margin by the respective clients using the points accumulated by the clients, and information of products which may be purchased at a discounted price using accumulated points for the respective clients, are stored.

Thus, when any of the clients accesses the shopping advertisement management sever SAMS through the associated client terminal among the client terminals A1˜An, the information of products which may be purchased at no profit margin by the client using the points, and other product information including the discount information associated with the client are concurrently displayed in the web browser on the terminal of the client. As a result, the system for managing the advertisement in the shopping mall web site can enhance the purchasing desire of the client through the advertisement viewing, thereby ensuring the profit margin of the product, sold at no profit margin to the supplier, by selling other products.

Here, the points are issued to the client in various forms in accordance with purchase contents. For instance, the system for managing the advertisement in the shopping mall web site issues one points per ten minutes in proportion to the advertisement viewing time of the client when the advertisement viewing time of the client is not over a predetermined time, two points when the client answers a question on a market research survey, and five to fifty points according to a price of the product when the client purchases the product.

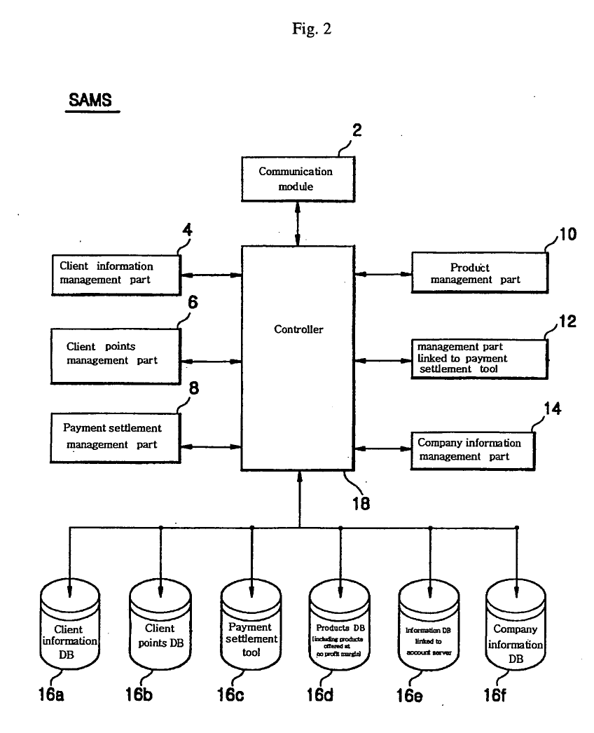

FIG. 2 is a block diagram illustrating the schematic configuration of the system for managing the advertisement in the shopping mall web site according to the first embodiment of the present invention.

Referring to FIG. 2, the shopping mall advertisement management server SAMS comprises a communication module, a client information management part, a client points management part, a payment settlement management part, a product management part, a management part linked to a payment settlement tool, a company information management part, a client information database (DB), a client points DB, a payment settlement tool, a products DB, an information DB linked to an account server, a company information DB, and a controller.

More specifically, reference numeral 2 denotes the communication module, which performs a process for sending or receiving a variety of data about the company servers PS1˜PSn and about the client terminals A1˜An, a protocol matching process for the data, and a process for coding or deciphering the data required for coding.

Reference numeral 4 denotes the client information management part for managing information of every client, and for performing verification of a client through comparison of stored ID and password of the client with ID and password input by the client, and reference numeral 6 denotes the client points management part for performing management to issue points of each client to the associated client terminal after performing calculation of the client's points according to advertisement viewing time and the number of clicks on the advertisement by the client through a previously installed calculation tool.

Reference numeral 8 denotes the payment settlement management part, linked to the client points management part, for transmitting selling information with a discount rate applied to the price of the product selected by the client, and for performing a payment settlement process after receiving a certified payment settlement signal.

Reference numeral 10 denotes the product management part for managing the product information supplied from the company servers PS1˜PSn after classifying the product information into information of products to be sold at no profit margin to the supplier, information of products to be sold at a discounted price, and the like. That is, since the profit margin of the products are differently allotted according to the products, the date of appearing on the market, and the like, the product management part performs the process for selling the product having the profit margin applied thereto and for applying the points to the profit margin of the product.

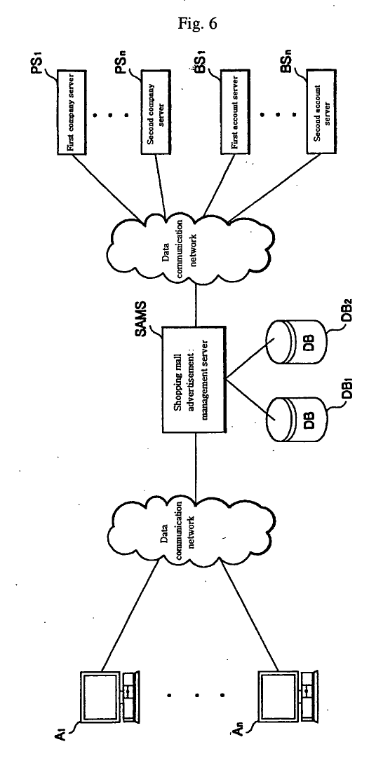

Reference numeral 12 denotes the management part linked to payment settlement tool for managing the payment settlement tool in a linked state, wherein the management part linked to payment settlement tool is linked to the account server (see FIG. 6) such that an Internet banking program of the client can be automatically operated in a multi-tasking on a main web page of the shopping mall advertisement management server. Reference numeral 14 denotes the company information management part for managing company's credibility based on the company information of each company until completion of shipping the product after payment settlement for the product.

Reference numeral 16a denotes the client information DB for storing the client information, and the information of IDs and passwords approved to the clients. Reference numeral 16b denotes the client points DB for storing data of the points accumulated by the clients according to the advertisement viewing time and the number of clicks on the advertisement by the clients.

Reference numeral 16c denotes the payment settlement tool, previously supplied from respective account servers and installed in the web browser on the client terminals to interface with the main web page of the shopping web site, for storing the Internet banking program of respective account servers, and reference numeral 16d denotes information DB linked to the account server for storing compatible server information in order to receive the payment settlement data reverse transmitted through the account servers. Reference numeral 16e denotes the company information DB for storing the information about the companies affiliated to the shopping malls, and information of company's credibility.

Reference numeral 18 denotes the controller for managing a shopping mall in the shopping mall web site to be linked to an advertisement mall therein. By the controller 18, the calculated points is issued to the client after the calculation for the points according to access information of the client, to the advertisement viewing time, and to the number of the clicks on the advertisement. Further, the information of products which may be purchased at no profit margin by the client according to the client's points is offered to the client in real time, along with other information of products which may be purchased at a discounted price by the points accumulated by the client. Moreover, the payment settlement is performed after receiving the certified payment settlement signal for the product, and verification information of the payment settlement is offered to the company server.

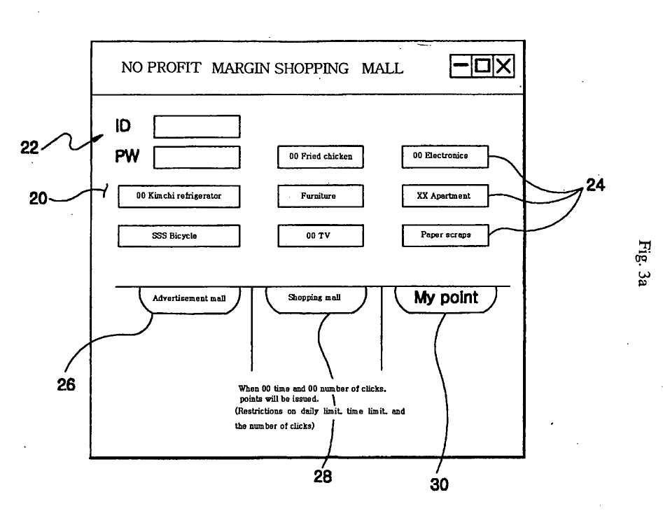

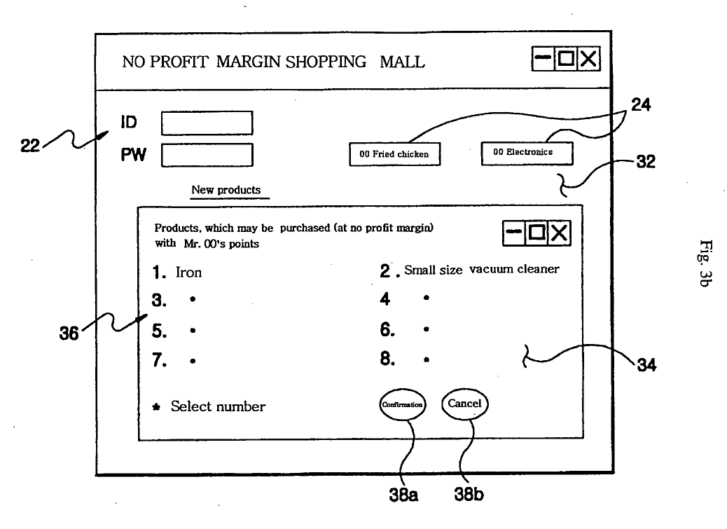

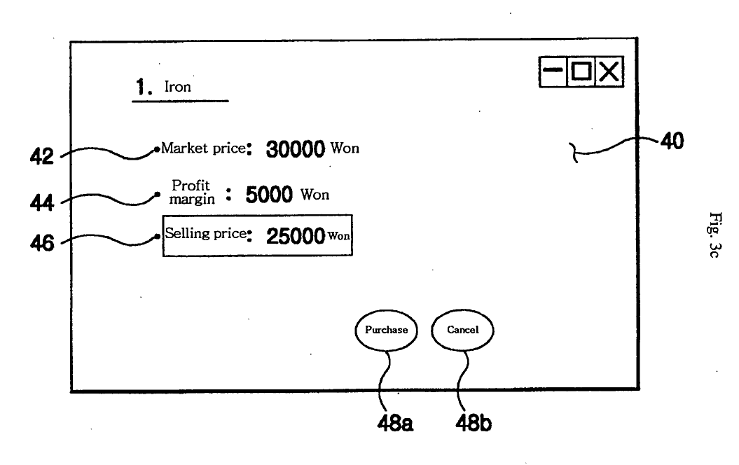

FIGS. 3a, 3b and 3c are diagrams illustrating a display shown in the web browser on the client terminal in the system for managing the advertisement in the shopping mall web site according to the first embodiment of the present invention.

Referring to the drawings, when the client accesses the shopping mall advertisement management server SAMS through the associated client terminal among the client terminals A1˜An, a main web page 20 as shown in FIG. 3a is displayed in the Web Browser on the associated client terminal.

Here, since each of the client terminals A1˜An is previously installed on the desktop thereof with an advertisement shopping-tool (not shown), if the client accesses the shopping mall advertisement management server SAMS by clicking an icon (not shown) signifying the advertisement shopping-tool, the shopping mall advertisement management server SAMS verifies whether the client is a member of the shopping mall web site according to the ID and password input by the client.

Furthermore, since basic data offered from the shopping mall advertisement management server SAMS through the advertisement shopping-tool is previously installed in the web browser of the associated client terminal among the client terminals A1˜An, the shopping mall advertisement management server SAMS offers only updated information to the client, who accesses the system. That is, if the client's points change, the shopping mall advertisement management server SAMS offers the product information, such as the information of products which may be purchased at no profit margin by the client using the points, discount percentage information thereof, and other information of products which may be purchased, not at no profit margin, but at a discounted price, and the like, to the client.

The main web page 20 is provided with input columns 22 for inputting the ID and the password used to verify the client's identity, and with a banner advertisement 24 for inducing the client to view or click the advertisement. Further, the advertisement shopping-tool previously installed in the client terminals A1˜An checks a period of time from opening the banner advertisement 24 as a sub-web page to closing the banner advertisement 24.

Furthermore, the main web page 20 is further provided with an advertisement mall hyper-linked icon 26, which is classified into directories for allowing more banner advertisements to be displayed, a shopping mall hyper-linked icon 28 for allowing access to the shopping mall, and a MY POINTS icon 30 for allowing access to the points information of the client.

Referring to FIG. 3b, when the client accesses the shopping mall advertisement management server SAMS through the associated client terminal among the client terminals A1˜An, the shopping mall advertisement management server SAMS automatically offers the updated information of products such that the information of products which may be purchased at no profit margin by the client using the points is displayed in the web browser on the client terminal.

Accordingly, the information of products, which may be purchased at no profit margin by the client, is displayed on the main web page 32 through a separate popup window 34 with icons 38a and 38b for generating a purchase confirmation signal and a cancel signal displayed thereon.

When the client selects a specific product (for example, an iron) on the popup window 34 in FIG. 3b, information 42 of the market price of the product, information 44 of a profit margin of the product, and information 46 of a selling price of the product are displayed on an additional popup window 40 for displaying a purchase and cancel icons 48a and 48b.

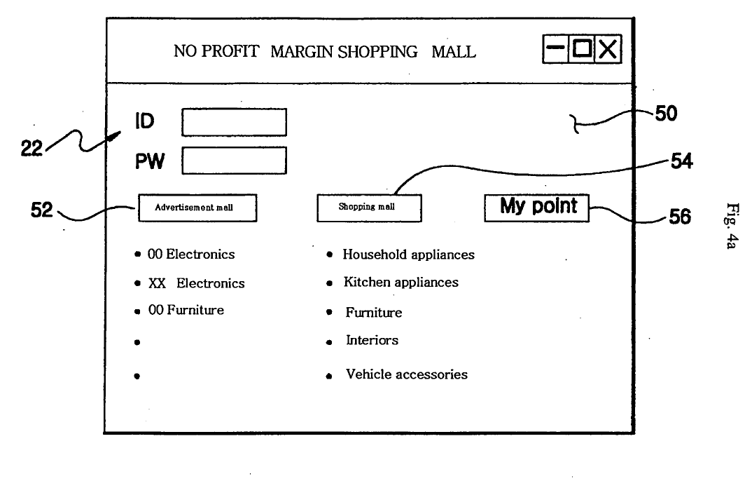

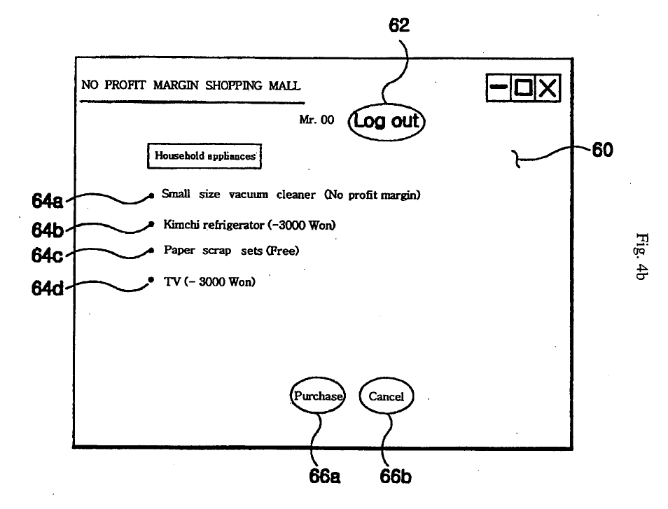

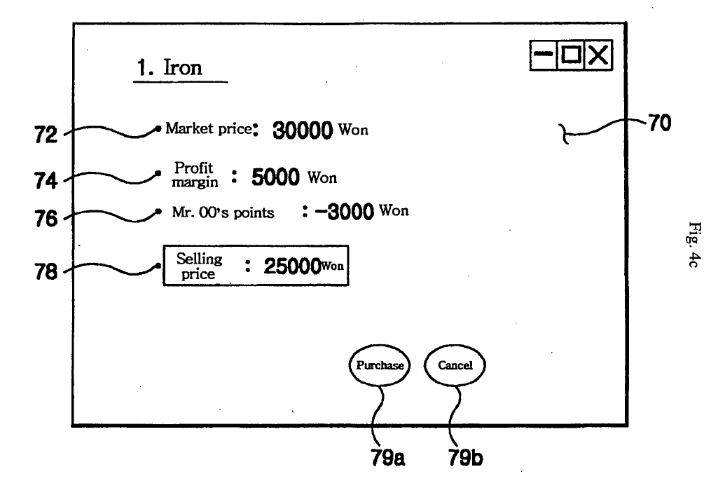

FIGS. 4a, 4b and 4c are diagrams illustrating another display shown in the web browser on the client terminal in the system for managing the advertisement in the shopping mall web site according to the first embodiment of the present invention.

Referring to FIGS. 4a to 4c, when the client accesses the shopping mall advertisement management server SAMS through the associated client terminal among the client terminals A1˜An, the shopping mall advertisement management server SAMS automatically offers a main web page 50 as shown in FIG. 4a. The main web page 50 is also provided with the input columns 22 for inputting the ID and the password.

The main web page 50 is further provided with an advertisement mall hyper-linked icon 52, a shopping mall hyper-linked icon 54, and a MY POINTS icon 30, such that the information thereof can be displayed according to respective directories. The shopping mall hyper-linked icon 54 is classified into detailed directories (for example, household appliances, kitchen appliances, furniture, interiors, vehicle accessories, and the like).

For instance, when the client selects the “household appliances” among the detailed directories, the sub-popup window 60 is displayed, as shown in FIG. 4b, on which separate indications showing information 64a of products which may be purchased at no profit margin by the client, information 64c of products which can be offered free, and information 64b and 64d of products which can be discounted are displayed. With regard to this, according to the present invention, since only the information updated for the respective clients by the advertisement shopping-tool previously installed in the client terminals A1˜An is transmitted from the shopping mall advertisement management server SAMS to the client terminals A1˜An, the capacity of the transmitted data is relatively small, and the information rapidly differentiated for the respective clients can be displayed.

As a result, the client can access the information 64a of products which may be purchased at no profit margin by the client, the information 64c of products which can be offered free, and the information 64b and 64d of products which may be purchased at a discounted price. Accordingly, the system for managing the advertisement in the shopping mall web site according to the present invention can enhance the desire to purchase other products as well as the products, which may be purchased at no profit margin.

Moreover, when the client selects not the products which may be purchased at no profit margin, but the products which may be purchased at a discounted price using the various information, a sub-popup window 70 as shown in FIG. 4c is displayed in the web browser on the associated client terminal among the client terminals A1˜An. Here, the sub-popup window 70 has market price information 72 of products, profit margin information 74 of products, and discounted price information 76 of products with the points converted into a certain sum of money, and selling price information 78 of the product displayed thereon. Further, a purchasing icon 79a and a canceling icon 79b are provided at a lower portion of the sub-popup window 70.

Function and operation of the system for managing the advertisement in the shopping mall web site according to the first embodiment of the present invention will now be described in detail with reference to the accompanying drawings.

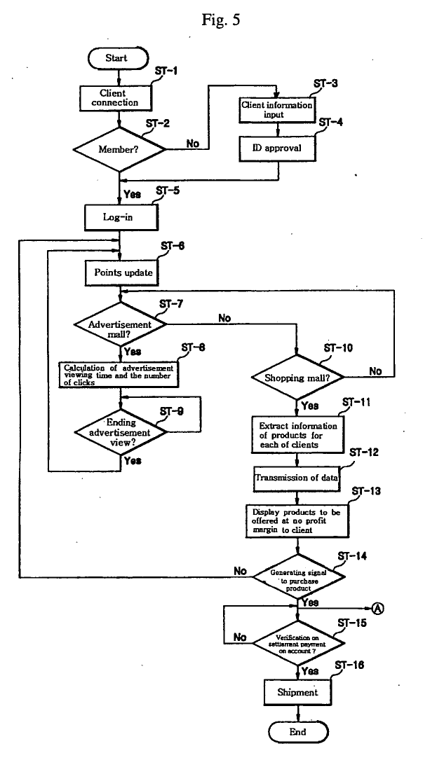

FIG. 5 is a flow diagram depicting signal flow in the system for managing the advertisement in the shopping mall web site according to the first embodiment of the present invention.

First, when the client accesses the shopping mall advertisement management server SAMS through the associated client terminal among the client terminals A1˜An (the fist step: ST-1), the shopping mall advertisement management server SAMS determines whether the client has a membership with the shopping mall web site or not (the second step: ST-2). If the client is not registered as a member thereof, the system for managing the advertisement in the shopping mall web site directs the client to input membership information through the client terminal, and offers an ID and a password (the third step: ST-3, and the forth step: ST-4) to the client.

When the client registers the membership, the shopping mall advertisement management server SAMS transmits a program for an advertisement shopping-tool to the associated client terminal such that the program can be setup therein, and after completion of the membership registration, the shopping mall advertisement management server SAMS directs the client to perform a log-in operation by inputting the ID and the password (the fifth step: ST-5).

After completion of the client log-in operation, the shopping mall advertisement management server SAMS issues sign-up points (for example, 100 points) to the client, and transmits information for updating the points to be displayed in the web browser on the client terminal. For instance, the shopping mall advertisement management server SAMS offers information of indicating the maximum daily advertisement viewing time, and information of points, which increase in proportion to the number of clicks and the advertisement viewing time, while being restricted as to the number of clicks allowed within a given interval (the sixth step: ST-6).

At this time, the shopping mall advertisement management server SAMS detects whether the client selects an advertisement mall in the web site (the seventh step: ST-7) or not, and performs calculation of the points according to the advertisement viewing time and the number of clicks by the client through the advertisement shopping-tool installed in the associated client terminal (the eighth step: ST-8).

Further, when advertisement viewing completion signal is transmitted via the advertisement shopping-tool in the associated client terminal, the shopping mall advertisement management server SAMS updates the client's points after the calculation of the points (the ninth step: ST-9).

If the client accesses the shopping mall (the tenth step: ST-10), the shopping mall advertisement management server SAMS extracts and transmits the information of products which may be purchased at no profit margin by the client using the points, and other information of products which may be purchased at a discounted price, to the associated client terminal. Accordingly, the information of products which may be purchased by the client using their points, is differentiated for the every client, and displayed on every associated client terminal among the client terminals A1˜An (the eleventh step: ST-11, the twelfth step: ST-12, and the thirteenth step: ST-13).

If the shopping mall advertisement management server SAMS receives a purchasing signal generated from the associated client terminal (the fourteenth step: ST-14), the shopping mall advertisement management server SAMS verifies whether the client has settled payment on account (the fifteenth step: ST-15), and when payment settlement on account of the client is verified, the shopping mall advertisement management server SAMS transmits the payment settlement information to an associated company server among company servers PS1˜PSn, thereby allowing the associated company to deliver the product to the client (the sixteenth step: ST-16).

The shopping mall advertisement management server SAMS of the invention performs a general process such as a purchasing process, a payment settlement verification process, a shipment signal generation process, and the like, in order that the calculation of the client's points may be performed, with the advertisement mall and the shopping mall automatically linked to each other, and that the client may purchase the products at no profit margin to the supplier or the products at a discounted price using the points.

A second embodiment of the present invention will now be described in detail with reference to the drawings.

FIG. 6 is a diagram illustrating the schematic configuration of a system for managing an advertisement in a shopping mall web site according to the second embodiment of the invention.

With reference to FIG. 6, the system for managing the advertisement in the shopping mall web site according to the second embodiment of the invention receives information of a plurality of products to be sold at no profit margin, supplied from a plurality of companies, and issues points to respective clients after detecting an advertisement viewed by the clients, advertisement viewing time, the number of clicks on the advertisement, and the like, when the advertisement in the shopping mall web site is viewed by the client after the client accesses the shopping mall web site through an associated client terminal among the client terminals A1˜An, in a state wherein an agreement as to payment for advertising on a per client basis, which is related to the number of clicks on the advertisement and to the advertisement viewing time, is negotiated between each of the companies and the system. Different from the typical points issued when purchasing a product, the points, issued from the system for managing the advertisement in the shopping mall web site depending on the advertisement viewing time and the like, allows the clients to purchase a desired product at no profit margin for the companies under the condition that the points issued to the clients are applied to a profit margin of the product to be offered to the clients at no profit margin. At this time, the shopping mall advertisement management server SAMS is linked to Internet banking tools offered from account servers BS1˜BSn, whereby the shopping mall advertisement management server SAMS allows the client to omit the cumbersome process of driving an additional Internet banking program after closing a shopping web page of the shopping mall web site.

Accordingly, when receiving a signal indicating payment settlement completion and a signal indicating payment without bankbook along with selection of client's bank by the client (in the case where the client employs the Internet banking), the shopping mall advertisement management server SAMS allows the system to be connected to a system of the bank so that an Internet banking display of the bank can be displayed in a web browser on the associated client terminal.

Here, a payment settlement signal and payment settlement data required for the Internet banking are transmitted in real time through the shopping mall advertisement management server SAMS to the associated account server among the account servers BS1˜BSn, where a certificate and payment settlement process is performed. Additionally, since the Internet banking system of the bank is linked to the shopping mall advertisement management server SAMS, the shopping mall advertisement management server SAMS can be offered in real time with a signal to verify the payment settlement of the client from the associated account server, thereby enabling the shopping mall advertisement management server SAMS to omit an additional verification process for the payment settlement of the client. Accordingly, it is possible to establish a shopping mall web site, which can perform rapid shipment through verification of the payment settlement of the client as well as a rapid payment settlement.

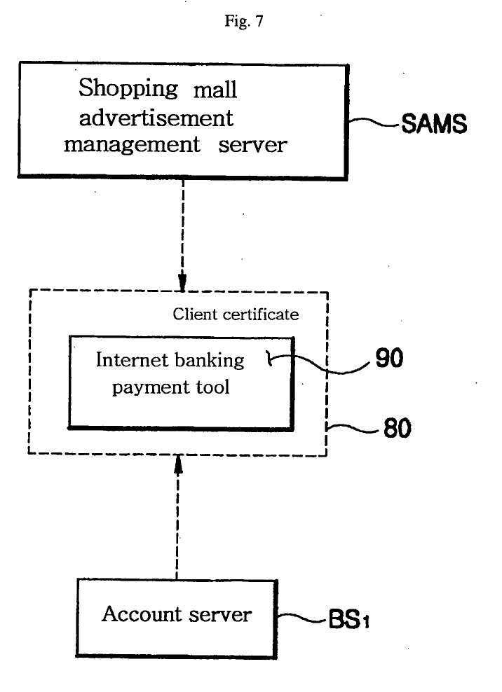

FIG. 7 is a diagram illustrating a payment settlement tool linked to the system for managing the advertisement in the shopping mall web site according to the second embodiment of the present invention.

Meanwhile, it should be understood that the system of FIG. 7 having the shopping mall advertisement management server SAMS linked to the account servers BS1˜BSn for performing the payment settlement process is an example of the present invention, and that there can be various modifications of the system within scope of the invention.

The shopping mall advertisement management server SAMS of the present invention offers an Internet banking payment tool 80, offered from the associated account server among the account servers BS1˜BSn to the client, and offers information of the client and information of a location of a certificate 90 to the associated account server in order that the associated account server can verify the certificate 90 in the client's terminal after easily recognizing the location of the certificate 90 in the client's terminal through the Internet banking payment tool 80.

The associated account server among the account servers BS1˜BSn performs processes for sending a signal indicating certificate verification for the certificate 90 and a signal indicating the payment settlement with the same method as that of the prior art. However, with this configuration, since the advertisement management server of the invention eliminates the necessity of the client to display the Internet banking window on the client terminal in order to perform the payment settlement for purchasing the product during shopping on the web site, it is very convenient for the client.

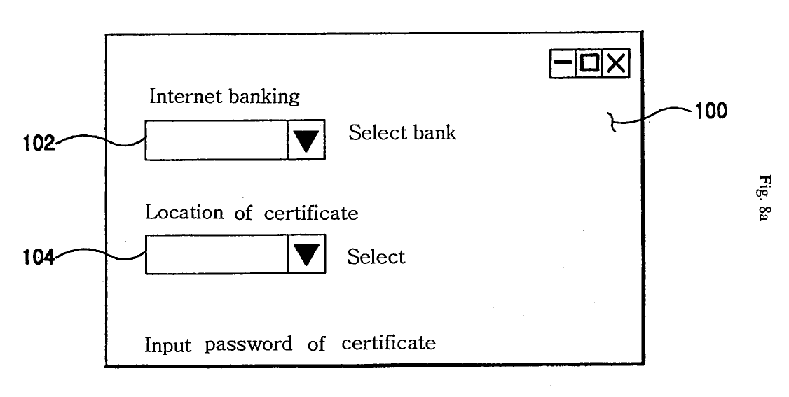

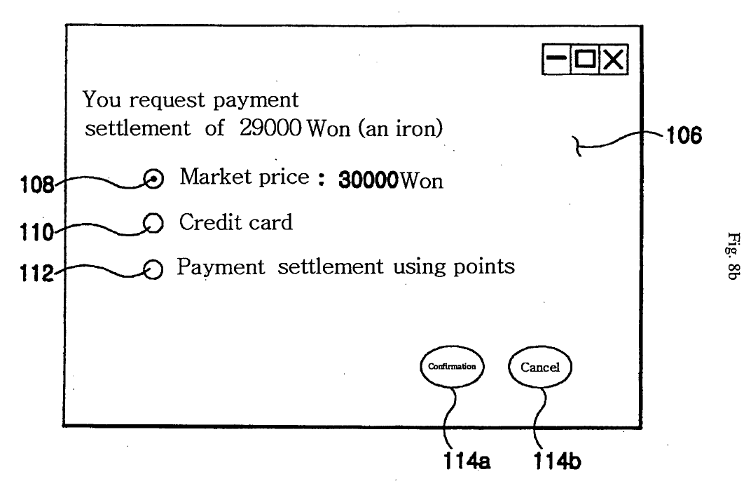

FIGS. 8a and 8b are diagrams illustrating displays of the payment settlement tool linked to the shopping mall web site in the system for managing the advertisement in the shopping mall web site according to the second embodiment of the present invention.

Referring to FIGS. 8a and 8b, when receiving the signal of the payment settlement for purchasing a predetermined product during shopping on the web site in a state wherein the client accesses the shopping mall advertisement management server SAMS through the associated client terminal, the shopping mall advertisement management server SAMS sends the payment settlement tool in the form of a main web page 100, provided thereon with an input column 102 for selecting a client's bank in order to connect the system to the account server through the Internet banking payment tool 80 of the bank, and with another input column 104 for selecting information of the location of the certificate of the client, to the associated client terminal.

If the client selects “00 bank”, and inputs “hard drive” as the location of the certificate, the shopping mall advertisement management server SAMS transmits the above information to the associated account server among the account servers BS1˜BSn. Then, the associated account server verifies the certificate of the associated client terminal among the client terminals A1˜An, and transmits the verification signal of the payment settlement for the product to the associated client terminal and to the shopping mall advertisement management server SAMS at the same time. Accordingly, it is convenient in that the shopping mall advertisement management server SAMS allows more rapid shipment of the product to be performed after receiving, in real time, the payment settlement information of products purchased by the client, and in that the shopping mall advertisement management server SAMS eliminates the necessity of the client to open additional Internet banking windows during shopping on the web site.

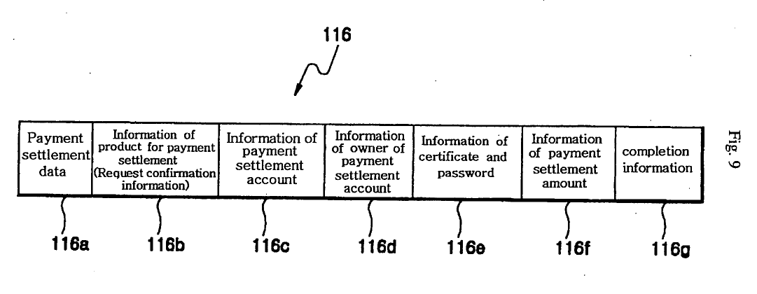

FIG. 9 is a diagram illustrating a data frame transmitted from the system for managing the advertisement in the shopping mall web site to the account server of the shopping mall web site according to the second embodiment of the present invention.

Referring to FIG. 9, when the client performs payment settlement using the Internet banking payment tool 80 linked to the shopping mall advertisement management server SAMS, the shopping mall advertisement management server SAMS may constitute a frame as shown in FIG. 9 using payment settlement data, and transmit the data frame to the associated account server among the account servers BS1˜BSn.

In this case, the data frame 116 comprises a header 116a for confirming that data therein is payment settlement data, information of an object for payment settlement (that is, the product information) 116b, information of a payment settlement account 116c, information of an owner of the payment settlement account 116d, information of certificate and password 116e, information of a payment settlement amount 116d, and completion information 116g.

Furthermore, instead of transmitting the data frame 116 to the associated account server, the shopping mall advertisement management server SAMS provided in the system for managing the advertisement in the shopping mall web site according to the second embodiment of the invention may be linked to the Internet banking payment tool 80 offered from the associated account server, such that the client may use the Internet banking payment tool 80 during shopping on the web site. In this case, the shopping mall advertisement management server SAMS does not form an additional payment settlement data frame, and all of the payment settlement signals are transmitted from the associated client terminal.

Function and operation of the system for managing the advertisement in the shopping mall web site according to the second embodiment of the present invention will now be described in detail with reference to the accompanying drawings.

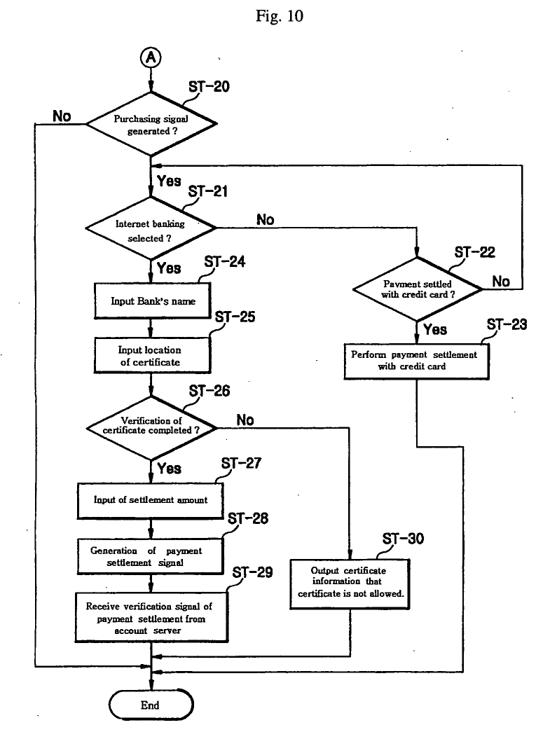

FIG. 10 is a flow diagram depicting signal flow in the system for managing the advertisement in the shopping mall web site according to the second embodiment of the present invention.

First, when the shopping mall advertisement management server SAMS receives the purchasing signal generated from one of the client terminals A1˜An in FIG. 5, the shopping mall advertisement management server SAMS determines whether the client selects Internet banking payment or credit card payment.

If the client selects payment settlement using a credit card, the shopping mall advertisement management server SAMS performs the payment settlement process using a credit card payment tool. Since the credit card payment tool is well known in the prior art, the description thereof will be omitted here.

If the client selects the Internet banking payment, the shopping mall advertisement management server SAMS directs the client to input the client's bank and the location of the certificate through the associated client terminal among the client terminals A1˜An. When receiving the information of the certificate, the shopping mall advertisement management server SAMS transmits the certificate to the associated account server among the account servers BS1˜BSn to verify the certificate.

After completing the verification of the certificate, the shopping mall advertisement management server SAMS allows payment settlement money of the product selected by the client to be automatically input thereto, and generates a payment settlement signal according to the client. For this purpose, the shopping mall advertisement management server SAMS provides the payment tool such that the shopping mall advertisement management server SAMS may interface with an Internet banking application offered from the respective account servers BS1˜BSn through the payment tool. Furthermore, the data for the various pieces of information of the payment settlement is coded such that the shopping mall advertisement management server SAMS cannot verify or read the data.

Meanwhile, when the account servers BS1˜BSn perform the payment settlement process after receiving the payment settlement signal, the account servers BS1˜BSn transmit the information of the verification of the payment settlement to the associated client terminals A1˜An and the shopping mall advertisement management server SAMS at the same time.

According to the embodiments of the present invention, the shopping mall and the advertisement mall are associated with each other on one web site, concurrently allowing advertisement viewing and on-line shopping in real time. Furthermore, as for the products sold at no profit margin to the supplier in the present invention, it does not mean that the products are sold as no profit margin products, but means that when the client achieves predetermined number of points or more in the shopping web site of the invention, the system for managing the advertisement in the shopping mall web site of the invention directs the company to classify the products to be offered at no profit margin to the supplier to the client, and disclose the products in the information of the shopping mall. That is, the product to be sold at no profit margin can act as an enticing product usually used in an off-line shopping store while directing the client to continuously view the advertisement, thereby enhancing the purchasing desire of the client.

As is apparent from the above description, according to the present invention, the system for managing the advertisement in the shopping mall web site, and the method thereof link the shopping mall and the advertisement mall to each other in one shopping mall web site, allowing the client to purchase a desired product using the points achieved by the advertisement viewing and the number of clicks on the advertisement, so that advertising effects of the company can be enhanced, and so that not only products to be sold at no profit margin but also the products to be sold at a discounted price are offered to the client, thereby enhancing the electronic commerce through the shopping mall web site according to the present invention. Furthermore, the client can achieve accurate product information through advertisement viewing, and can purchase the desired product at no profit margin to the supplier using the accumulated points issued as payment for the advertisement viewing, so that the client can purchase the product with a lower price by an amount corresponding to the discounted profit margin of the product.

It should be understood that the embodiments and the accompanying drawings as described above have been described for illustrative purposes and the present invention is limited by the following claims. Further, those skilled in the art will appreciate that various modifications, additions and substitutions are allowed without departing from the scope and spirit of the invention as set forth in the accompanying claims.

What is claimed is:

1. A system for managing an advertisement in a shopping mall web site, comprising:
a shopping mall advertisement management server for managing a plurality of shopping mall web sites, for displaying information of products, to be offered at no profit margin to a supplier, after receiving the information of products from a company, for performing calculation of points required for the client to purchase a product by reducing a profit margin of the product in proportion to advertisement viewing time and the number of clicks on an advertisement by the client, based on an agreement as to payment for advertising on a per client basis, and then offering calculated points to the client connected to the shopping mall advertisement management server, thereby performing purchase and payment settlement for the product in real time;
a client terminal with a communication module embedded therein, such as a modem or a dedicated cable, and a web browser for generating an advertisement connection signal while allowing the client to view the advertisement after connecting to the shopping mall advertisement management server for managing the plurality of shopping mall web sites; and
a company server for offering the information of products and of the number of products to be offered to the client at no profit margin to the supplier while being offered with information of calculation of the payment for advertising on a per client basis according to the advertisement viewing time and the number of clicks on the advertisement by the client connected to the company server via the shopping mall advertisement management server when the shopping mall advertisement management server is connected to the company server.

2. The system as set forth in claim 1, wherein the shopping mall management server offers an advertisement shopping-tool to the client terminal for automatically updating the information of products to be purchased by the client using client's points at no profit margin to the supplier, together with information of products to be purchased at a discounted price by applying the points accumulated by the client to discount a price of the product, in the web browser on the client terminal.

3. The system as set forth in claim 1, wherein the information of products offered by the shopping mall advertisement management server is classified into information of products to be purchased at no profit margin to the supplier by the client using the points accumulated by the client, information of a discounted price of the product, and information of products to be only discounted in price.

4. A method of managing an advertisement in a shopping mall web site, comprising the steps of:
a) receiving a signal to access a shopping mall advertisement management server by a client through a client terminal;
b) certifying a client's identity in the shopping mall advertisement management server;
c) offering an advertisement shopping-tool to the client terminal from the shopping mall advertisement management server such that the advertisement shopping-tool may be installed in the client terminal;
d) issuing points to the client in proportion to advertisement viewing time and the number of clicks on an advertisement by the client when receiving a signal indicating advertisement viewing, transmitted from the client terminal;
e) updating client's points by performing calculation;
f) receiving a signal to access a shopping mall in the shopping mall web site by the client through the client terminal;
g) extracting and transmitting information of products to be purchased at no profit margin to a supplier by the client using points accumulated by the client, and information of products to be purchased at a discounted price by the client to the client terminal;
h) displaying the information of products to be purchased at no profit margin to the supplier by the client using the points accumulated by the client, on the client terminal, after classifying information of products, to be purchased using the client's points, corresponding to the client;
i) receiving a purchasing signal and a payment settlement signal transmitted from the client terminal;
j) verifying payment settlement on account from the client terminal; and
k) performing shipment of the product purchased by the client.

5. The method as set forth in claim 4, wherein the shopping mall advertisement management server automatically offers the information of products to be purchased at no profit margin to the supplier by the client using the client's points, and information of products to be purchased at a discounted price by the client when receiving the signal to access the shopping mall advertisement management server by the client through the client terminal.

6. The method as set forth in claim 4, wherein the points issued according to the advertisement viewing time and the number of clicks by the client are restricted to a daily limit.

7. The system as set forth in claim 1, wherein the system further comprises an account server for offering an Internet banking payment tool to the shopping mall advertisement management server, and the Internet banking payment tool is linked in a multi-tasking to the account server such that the Internet banking payment tool may be automatically operated in the web browser on the client terminal.

8. The system as set forth in claim 1 or 7, wherein the shopping mall advertisement management server transmits information of a client's bank, certified in the client terminal, and of a location of a certificate in the client terminal to the account server to perform the payment settlement.

9. The method as set forth in claim 4, further comprising the steps of:
l) generating payment settlement command information performed according to the payment settlement signal transmitted from the client terminal;
m) transmitting payment settlement command information to the account server through the shopping mall advertisement management server; and
n) receiving payment settlement verification information automatically transmitted from the shopping mall advertisement management server to an IP address of the shopping mall advertisement management server included in the payment settlement command information.
